(19) United States
(12) Patent Application Publication
(10) Pub. No.: US 2008/0122298 A1
(43) Pub. Date: May 29, 2008

(54) Arc-break non-electric permanent magnet motion using racks and/or rails set

(76) Inventor: Joseph Stuart Roberts, North Augusta, SC (US)

Correspondence Address: J. Stuart Roberts, 101 Windy Mill Drive, North Augusta, SC, 29841, US

(21) Appl. No.: 11/604,322

(22) Filed: Nov. 27, 2006

(51) Int. Cl. G09B 23/18; H02K 21/00; H02K 23/04; H02K 21/12

(52) U.S. Cl. 310/1; 310/152; 310/156.45; 310/154.03; 310/154.24

(57) ABSTRACT

This abstract section is written to explain this patent application. A magnetic motion has been found utilizing the sides and corners of permanent magnets. This motion has been taught at public schools by myself and the magnetic motion at certain angles continues to perform without fail. The intent of this inventor is to continue to develop and teach this magnetic motion and the set-up to achieve this motion. An engine/motor capable of picking up a load, while under a load is the final goal of this effort. This patent is for a magnetic motion, a magnetic motion demonstrator, and a teaching tool itself. Any future engines/motors using this method of magnetic motion will fall under this patent in the fundamental's area only not in the individual improvements of future patents. If allowed, an itemized list of non-patent-able fundamentals/techniques will be included.

### BACKGROUND

There are three sources of energy that cannot be re-fueled without changing the original source of energy. The energy of vacuum, the energy of gravity and the energy of magnetism. This inventor believes that global warming is real and is caused by human endeavors. The energy of vacuum is the least understood, followed by the energy of gravity, and then by the energy of magnetism.

By using permanent magnets, a motion was found in 1997. This now called, arc-break motion, demonstrated the physics term “work” without the use of fuel. This arc-break motion is directly related to angles of magnets. In 1998, after many dead ends, an additional angle was found. A few years later a demonstrator was built and the arc-break motion was demonstrated at local public schools. These public schools range from elementary to high schools. Within the last year, larger more complex demonstrators have been built and the arc-break motion with modifications has been demonstrated again at public schools. The students at the high school convinced me to apply for a patent.

### SUMMARY

As mentioned in the background section of this paper, a system to produce energy without the use or need for re-fueling is currently being researched. An arc-break magnetic motion has been found and has been taught within the South Carolina public school system.

The invention being applied for is a multi-part teacher's aid and the principles for a future car engine and motor which requires no fuel. The invention, instead of one machine that would intimidate the interested student and bore the uninterested, is designed to be simple, hands-on, and multi-part. There are two reasons for multi-parting the invention: first, boredom of all students as in rebuilding one machine to demonstrate an additional feature; second, so not to intimidate all students as to their current experience level and lack of knowledge confidence. Losing the students attention takes about five seconds due to student fatigue and lack of physical exercise, so changing out parts of the machine in the classroom is ill-advised. Shock knowledge disrupts everyone's confidence on what they currently believe is true, and has a lock-down affect on absorption of new information. Initial complex introductions are also ill-advised, unless you want to impress how smart you are which is NOT TEACHING.

Within the body of this patent application will be diagrams, drawings, and descriptions. The diagrams will aid those individuals who would like to teach by displaying the arc-break motions of the demonstrators. The drawings will aid those individuals who would like to build by drafting a crude, inexpensive and working magnetic arc-break motion demonstrator. The tone of the text will drift from very dry technical data to layman's language in an attempt to maintain brain absorption. The naming or designating part titles to individual items will range from long-winded descriptors to the reuse of familiar or common item names. Remember this is new material and therefore no names exist.

The systems are new and will require the “feel to find” technique. “Feel to find” (a.k.a. “trim and try”) technique will be needed for the range of on-hand or available Therefore, the physic and engineering formulas will not be supplied. Once the demonstrator is built and motion obtained, contact your local high school physic teacher for the required formulas.

Standards, one must start somewhere. Throughout the text, words like standard magnets, standard angles, and standard rack may appear. These standards will be the starting points and/or serve as reference points because these items were the first this inventor achieved points of repetition. Standard plus or standard minus points will be avoided at this time, for these terms serve little value during initial building. Standard plus or standard minus will be reserved for future papers. The list of Standards are found below:

### List of Standards

1. 23.4° the angle for setting the non-moving magnets. This system works 100% of the time. Special note: 23.4° is the tilt of the Earth (ironic isn't it)
2. Magnet here the standard magnet is actually two permanent magnets that have been cleaned and taped together. The individual magnets used to make a standard are Radio Shack® part no. 6401877.
3. Rack the standard rack is a 45° arc of wood placed outside a circle having a radius of 12.5 inches. The rack has what is referred to as a “medium gap.” The “medium gap” are the gaps between the magnets ranging from three-eighths of and inch to one-half inch.

Sloppiness is allowed for technical reasons with proper shielding. Exact measurements and precise fabrication is not necessary except for one item. By using the standard angle of 23.4°, a large range of multiple misses can be achieved and the system will continue to work. Some measurements can be as far off as 100% and this missed mark will not be noticed. The one item which needs to be fabricated with the highest degree possible by the builder is called a “key”. The key will be discussed later.

Sloppiness is not allowed for safety reasons in building and demonstrating the magnetic motion. The builder must consider the quality of material, skill level of personnel, and appropriate shielding for the demonstrator or engines. See teachers supplemental for guidelines on classroom demonstrators.

Variations to the arc-break magnetic motion will also be listed within this patent application. All demonstrators can vary in size, shape and suitable materials of construction. All arc-break racks and rails can vary in radius, depending on the magnets used. All arc-break racks and rails can vary in degrees of length. All arc-break racks and rails can vary in number around the circle which influences the rotor. All arc-break racks and rails can vary in appropriate materials of construction. All rotors can vary between arm style or disk style rotor. All rotors can vary in diameter depending on the strength and shape of magnets used. All rotors can have varying number of magnets which will depended on shape and make-up of the distributor. All distributors can vary in size and shape depending on the size of the rotor and what the distributor will be used for. The distributors can either be set up for teaching or mechanical hook-up, but not both. The controller can either exist or not exist. If the controller exists, it can vary in size and shape, depending on the size of the rotor. Finally, all timing controls, shaft connections, magnets and mechanical connections can vary using the arc-break magnetic motion.

MOST PATENT APPLICATIONS PERTAIN TO ONE ITEM. This patent application also pertains to one item: a build-it-yourself-ready-for-mechanical-hook-up-arc-break-magnetic-motion-device. This one item needs to be understood by all who read about, attend a demonstration, or try to build this one item.

Remember that all of the demonstrators within the body of this patent application can be combined into one unit that would impress the public, limit the would-be builder, and mislead future designers by their lack of fundamentals. Therefore, the demonstrators are described as a single set. A teacher's supplemental, non-patent-able list, and inventors intent will be part of this patent application if the USPTO will allow.

This patent application will have detailed descriptions of the most important parts of an arc-break magnetic motion device. Items like glue, tape, boards, screws, marking pens, pencil marks, rulers or rules, compass, protractors, saws, drill press, wrenches, screwdrivers and other generic material of construction will not be described in great detail. The demonstrators are either table top or mounted on stands (saw horses

### INDEX OF DRAWING DESCRIPTIONS

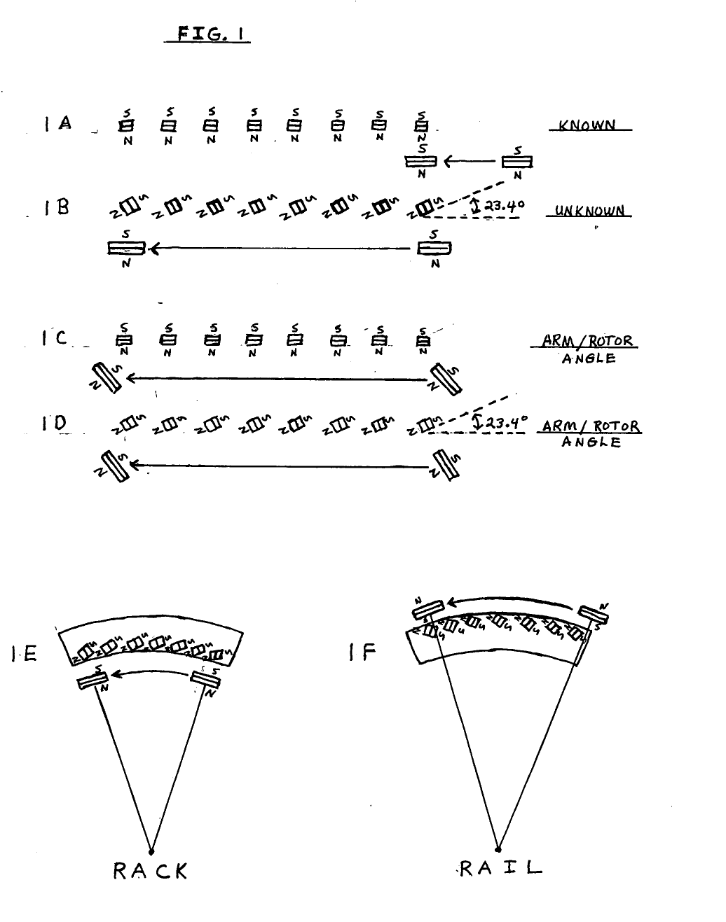

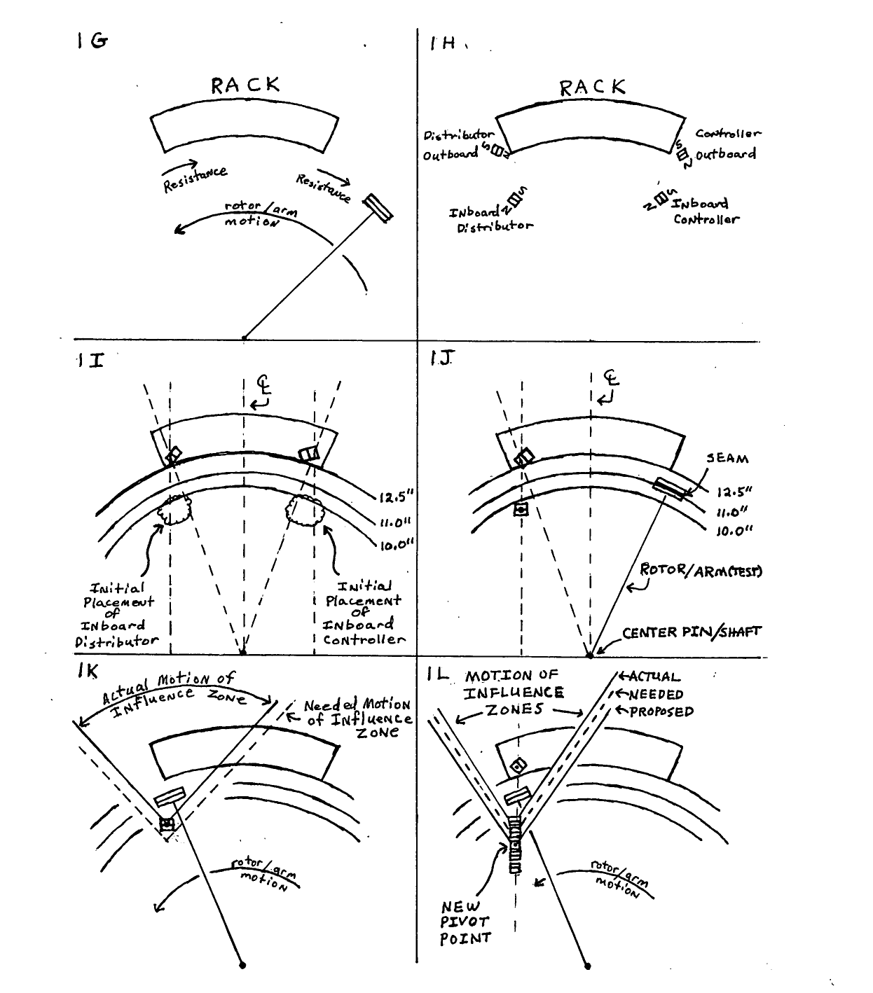

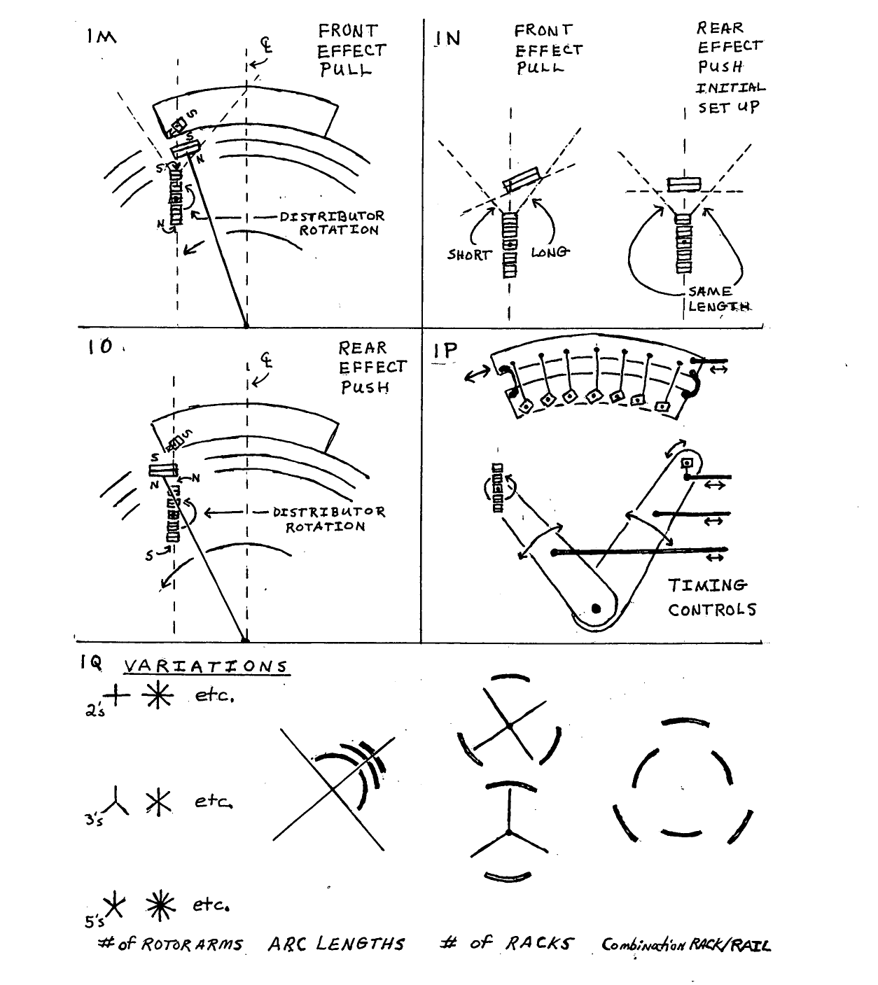

FIG. 1 Diagrams
1) 1A what is widely accepted as a truth that a magnet will not move from one magnet to another
2) 1B states that FIG. 1A is false
3) 1C shows an alternate method from FIG. 1B
4) 1D shows that a magnet can move even with two angles
5) 1E diagram of a rack
6) 1F diagram of a rail
7) 1G shows magnetic resistance to overcome
8) 1H shows how to overcome magnetic resistance
9) 1I shows initial placement of inboard controller/distributor
10) 1J shows final placement of distributor
11) 1K shows needed location of distributor for mechanical hook-up
12) 1L shows how to achieve location in FIG. 1K
13) 1M diagrams “front effect pull”
14) 1N shows difference between “front effect pull” and “rear effect push”
15) 1O shows distributor placement for “rear effect push”
16) 1P shows timing controls
17) 1Q diagrams variations

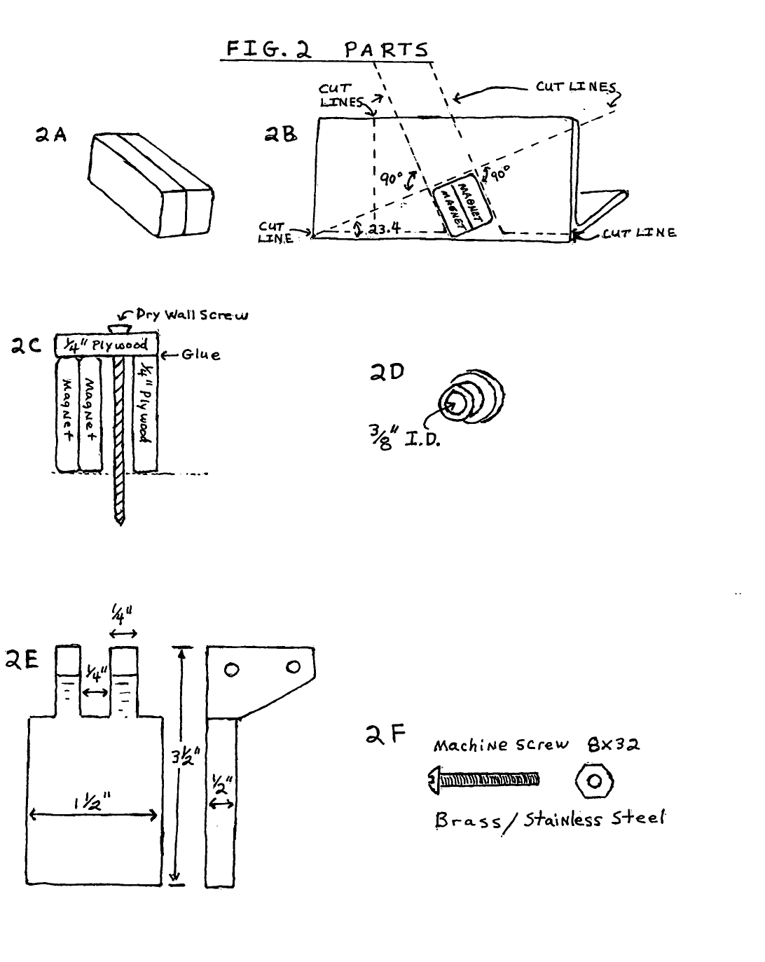

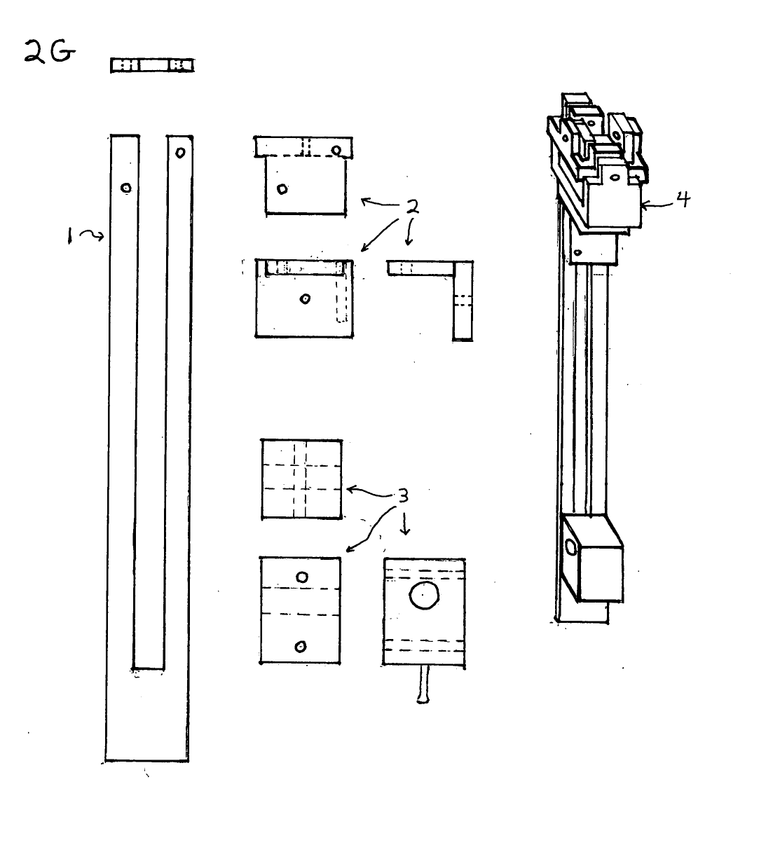

FIG. 2 Parts
18) 2A Radio Shack® part number 6401877 (2 each) magnets
19) 2B diagrams cutting of a key
20) 2C sketch of a simple top mount for magnets
21) 2D Snapper® riding lawnmower part number 13321 bushing
22) 2E diagram of a typical “drop mount”
23) 2F sketch of a brass or stainless steel machine screw and nut 8×32
24) 2G diagram of a straight mount with test head (size varies with magnet being tested)
25) 2G (second page) details test head assembly (size varies with magnet being tested)
26) 2H sketch of insert style rack of clockwise rotation
27) 2I sketch of insert style rail of clockwise rotation
28) 2J classroom style, manual distributor with bottom handle (size varies with distributor magnet)
29) 2K classroom style, manual controller or manual distributor with top handle (size varies with controller/distributor magnet)

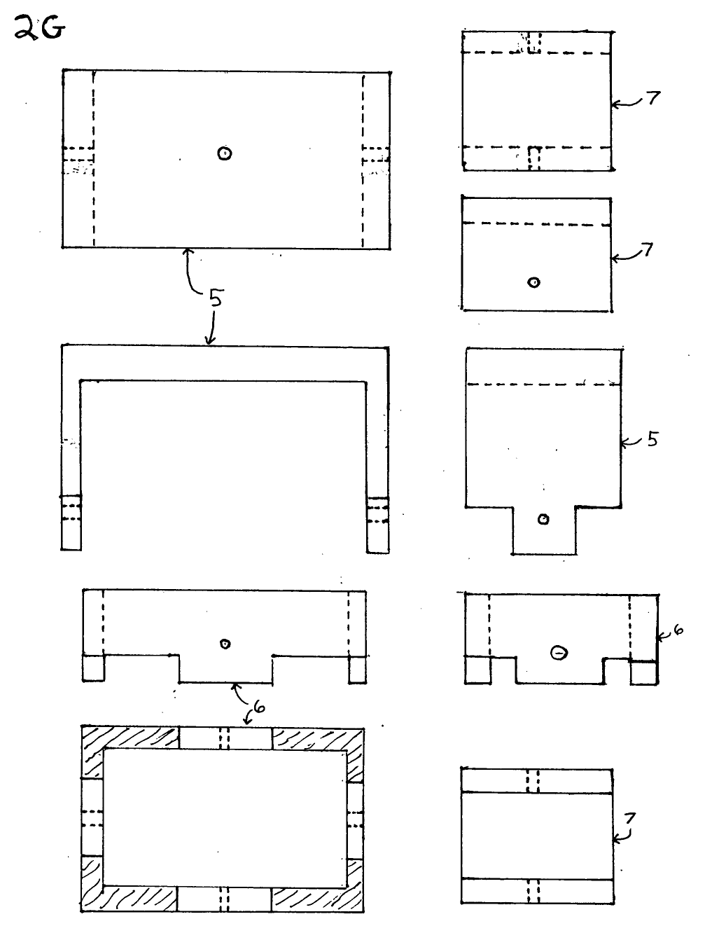

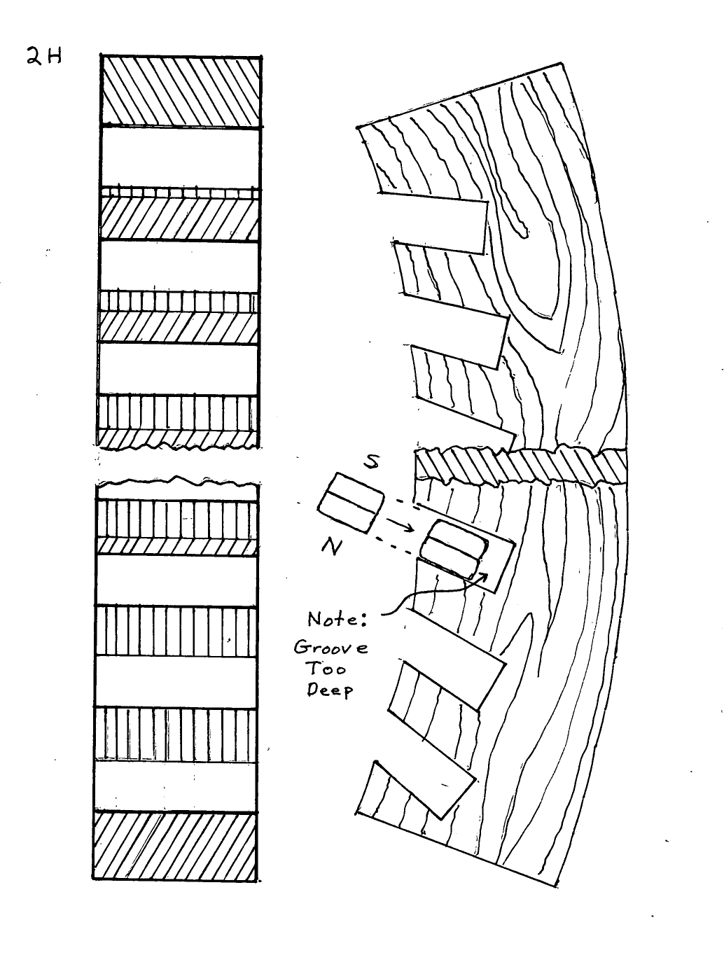

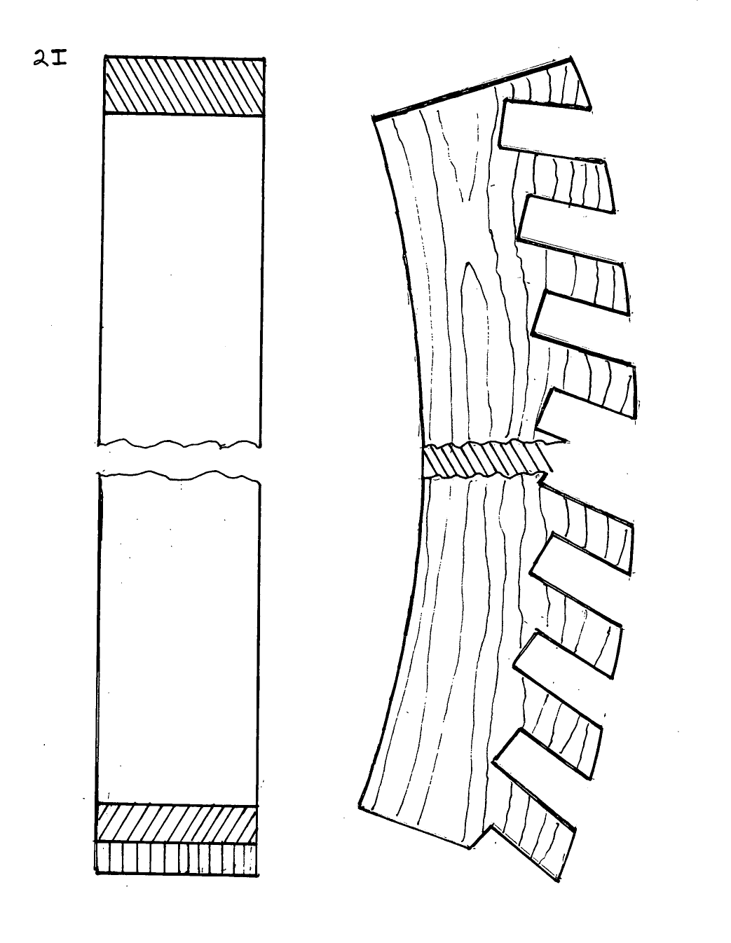

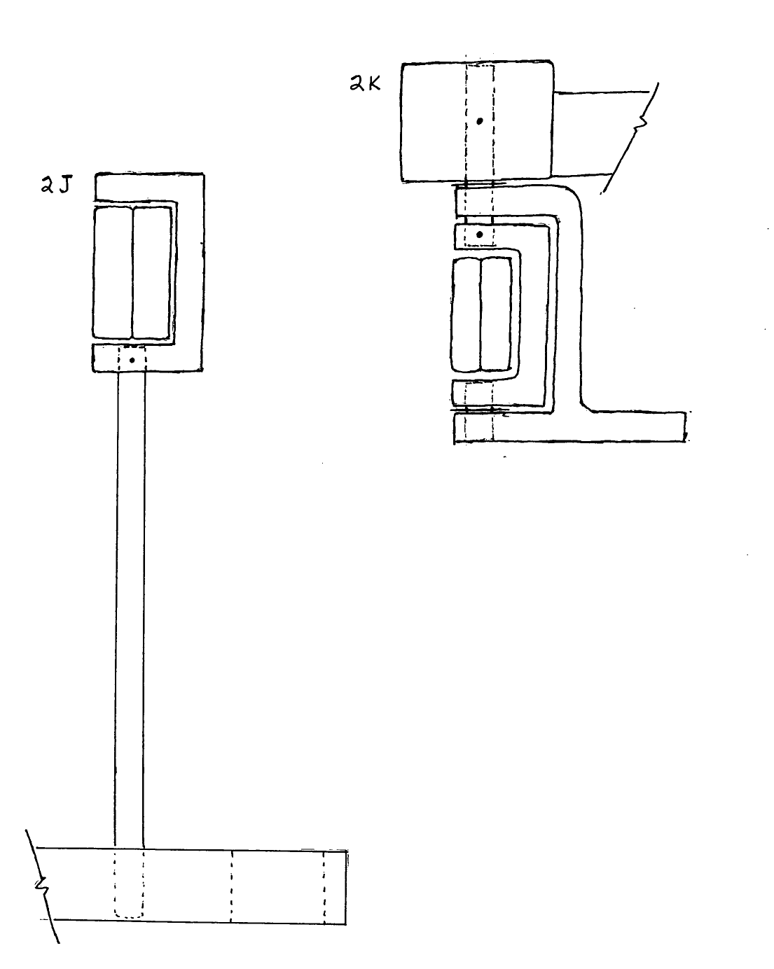

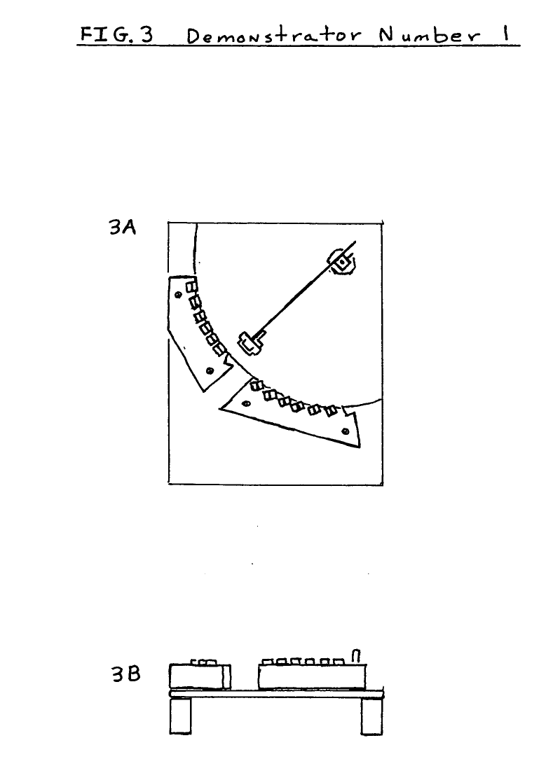

FIG. 3 Demonstrator Number One
30) 3A top view of Demonstrator Number One
31) 3B side view of Demonstrator Number One

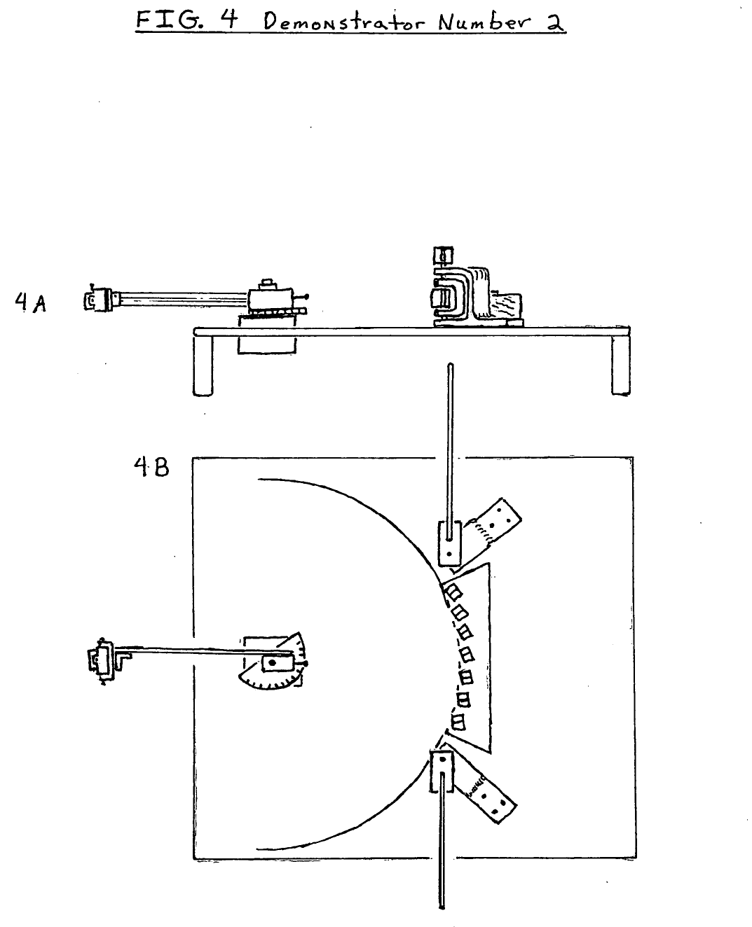

FIG. 4 Demonstrator Number Two
32) 4A side view of Demonstrator Number Two
33) 4B top view of Demonstrator Number Two

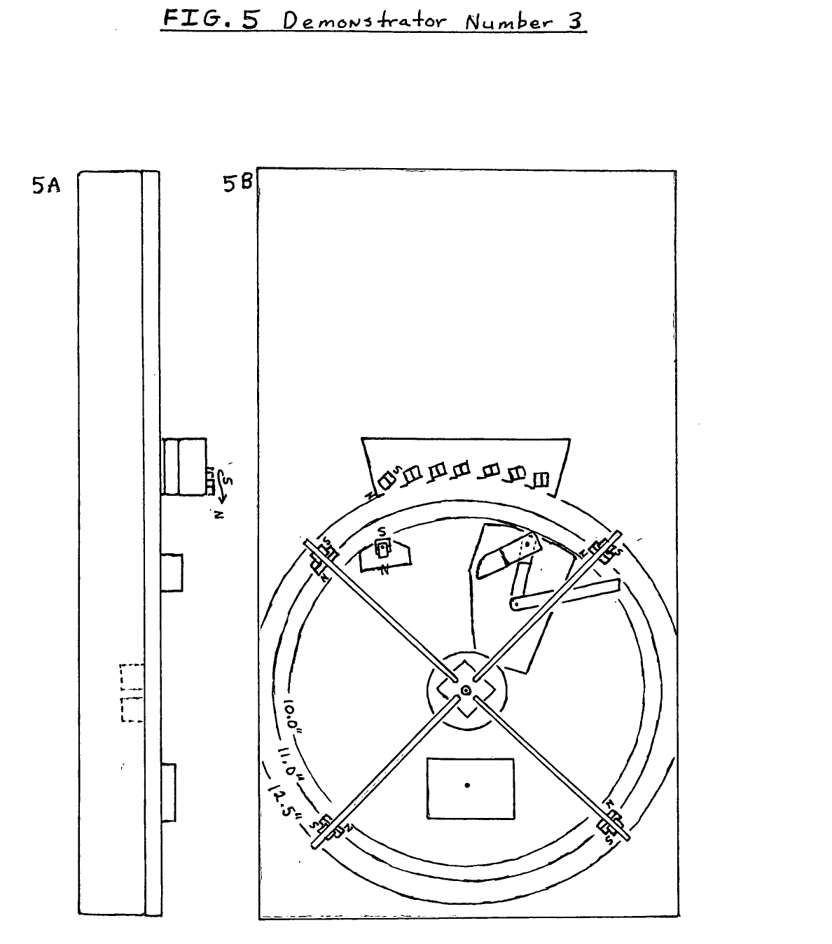

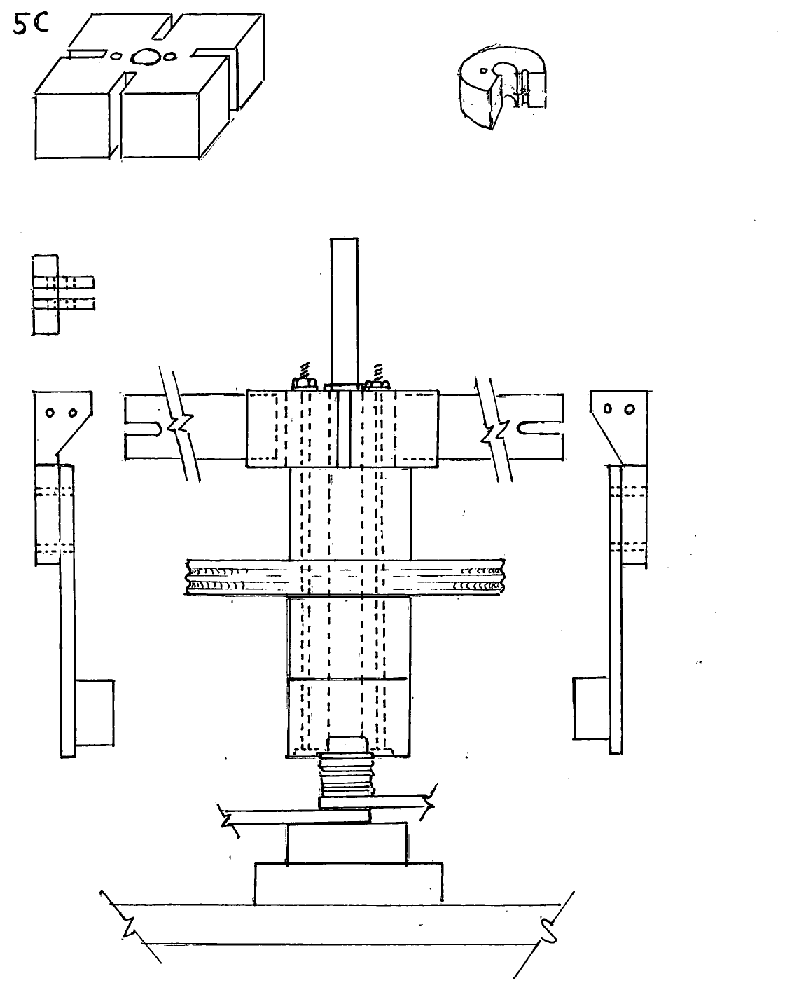

FIG. 5 Demonstrator Number Three
34) 5A side view of Demonstrator Number Three without rotor, distributor and controller
35) 5B top view of Demonstrator Number Three
36) 5C sketch of rotor diagram

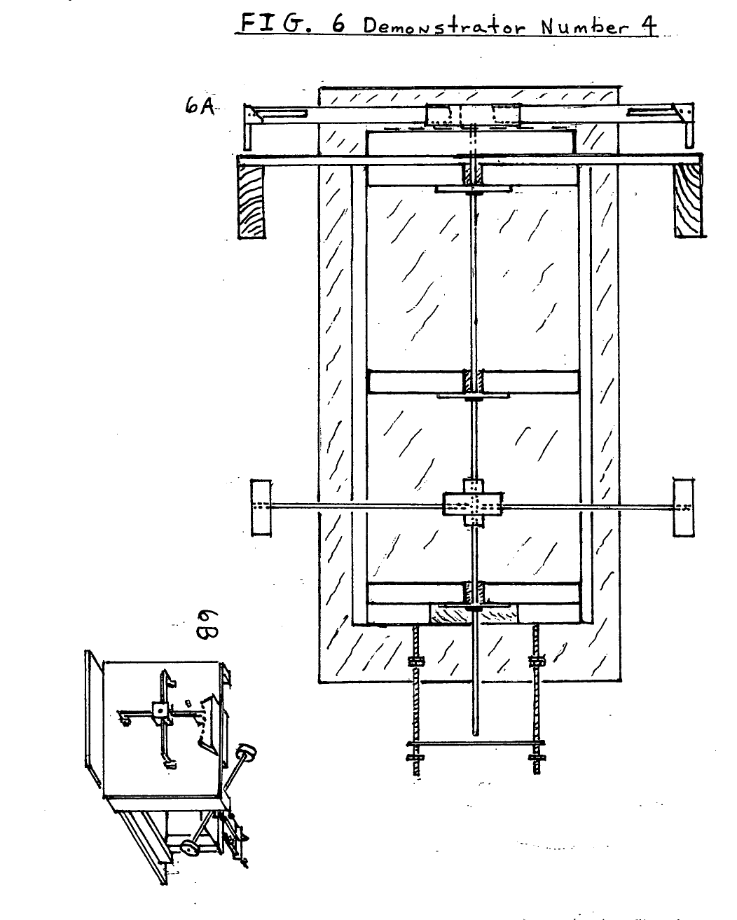

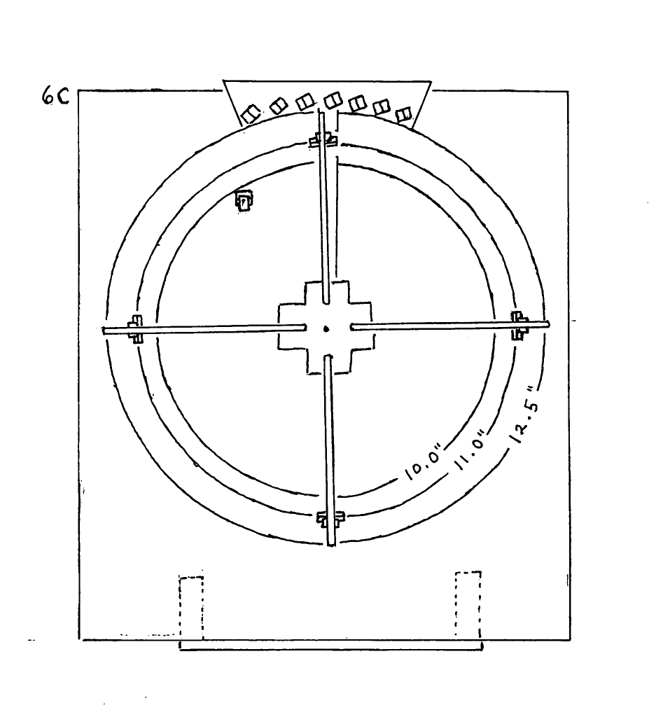

FIG. 6 Demonstrator Number Four
37) 6A top view of Demonstrator Number Four
38) 6B isometric view of Demonstrator Number Four
39) 6C front view of Demonstrator Number Four

### DETAILED DESCRIPTION

### Magnet

The magnet used for testing and demonstrating is actually two Radio Shack® magnets, part number 6401877 taped together. Prior to taping, the magnets are cleaned by using masking tape that is wider than an individual magnet is long. The cleaning process is to remove the ever-present magnet particles, as in loose magnet dust and magnet debris. This dust and debris are particles of the magnet, not just magnetic crud or magnetized hitchhikers. The two magnets must be repeated placed on the masking tape until no visible dark gray specks appear on the masking tape. All six sides of each magnet must be done this way.

Next, place the two magnets together, aligning all sides. This is a normal placement or opposite attracting sides together. A long piece of one-inch masking tape is then wrapped around the two magnets, seam-wise. Seam-wise means up the east side, over the top, down the west side around the bottom back to the east side. This taping prevents particles from entering between the two magnets. The over hang on the north and south sides of the now formed single magnet, can and should be folded down to form a paper bordered bumper. This bumper will help prevent cracking, chipping, or breaking of the magnet. The magnet (formerly two magnets) will quickly start attaching itself to all unwanted items nearby; and without some masking tape protecting it, the magnet will eventually break-up.

Some things to take into consideration when purchasing these magnets include the following. First, are these the size magnets you really want: the arc-break motion can be performed with any medium grade, square or rectangle magnet (except the rotor/arm needs a rectangle.) Secondly, do not use chipped, cracked or broken magnets. Thirdly, the Radio Shack® magnets part number 6401877 have been found to come in different sizes: over the many years, these magnets were found to vary in length and this difference in length does matter. Mixed sizes of magnets should not be used. Cost is the final factor to consider. Currently the cost per magnet is about $2.00-$2.50. To make a set of 15 taped-sealed magnets will require 30 magnets or about $75.00.

Marking all the tape-sealed magnets with a dark, bold marker is a time saving necessity. Simply drawing arrows on all four sides of each tape-sealed magnet will lessen future frustrations. Attach tape to all on-hand magnets and mark each with the arrows all pointing in the same direction. These arrows of attraction can either be pointing north or south. The arc-break motion does work with either the north face, or pole, of each magnet directed towards the rotor, or test arm, or the south face, or pole directed in the same direction. By using the “arrows of attraction”, the construction of demonstrators is made easier. For diagramming purposes in this patent application, the standard letters “N” and “S” will be utilized.

Finally, a future theoretical faceted magnet will be needed. This faceted magnet(s) should be semi emerald cut with a raised wedge. This future magnet will reduce the number of additional angles found to work on the test arm and the rotor.

### Angles

There are six magnet angles that can be obtained with square or rectangular magnets. Three on the non-moving magnets and three on the moving magnets. The performance data from the six angle positions will fill a book which will not be completed in my lifetime. Here the need for shaped or faceted magnets becomes apparent. Rectangular magnets are preferred in both the moving and non-moving positions. Square magnets can be used in the non-moving position only if these are large enough to cover any angle of the moving rectangular magnet. When using rectangular magnets, the long end of the non-moving magnet needs to be in the same direction as the main rotor shaft or center pin on the test arm and the long end of the moving magnet needs to be perpendicular to the main rotor shaft or center pin on the test arm. When using square magnets as the non-moving magnets, the rectangular magnets or moving magnets will need to be perpendicular to the main rotor shaft of center pin on the test arm.

Only two of the six magnet angles will be discussed in depth within this patent application. The other four angles, though workable, would best be explained in a classroom setting. Of the two angles for this patent application, one will be for the non-moving magnets and the other will be for the moving magnets. The non-moving magnets will be placed in/on devices that will be referred to as racks or rails. The moving magnets will be placed on the ends of devices that will either be referred to as arms or rotors.

“East/west wave compression” should be discussed in a classroom setting, but will be covered briefly in this patent application to hopefully prevent frustration by future inventors/builders. “East/west wave compression” shows up twice during the building of an arc-break system. The first situation deals with the racks or rails. The second situation deals with the setting of the distributor for mechanical hook up.

“East/west wave compression” deals with the sides of a magnet not the north and south ends of a magnet. A short-sided magnet or a slab magnet has a compressed east/west wave. A long-sided magnet or a bar magnet has an elongated thin east/west wave. This is best demonstrated by using a medium sized bolt. By using the side of a slab magnet, the bolt will be lifted. By using the middle of the side of a long bar magnet, the bolt will not be lifted. The east/west wave is still there on the long bar magnet but this wave exists very close to the bar magnet itself. On the rack and/or rails, the rotor/arm magnet(s) are riding the east/west wave. On the mechanical hook up for the distributor, the east/west wave will interfere with the operation at this point.

Using different slab or bar magnets were not tried on the racks and/or rails, but the future testing of the east/west wave will be performed. From a bird's eye vies, two (Radio Shack® part number 6401877) magnets placed together, in the vertical position, appear to be near equal sided. So this magnet arrangement is neither slab or bar shaped. This near square sided magnet arrangement now becomes the reference point for adjusting to a slab or a bar arrangement on the racks and/or rails.

Gaps between the magnets on the racks and/or rails are limited to slightly larger than the length of the east/west side of a near square magnet; down to zero gap (no space between magnets.) As the gaps between magnets are reduced, the east/west wave effect on the rotor/arm becomes stronger. This is not necessarily good. The magnet on the rotor/arm may have to be adjusted (slightly increase or reduce the radius of the rotor/arm magnet.)

Returning to the two angles, the first angle to be discussed deals with the racks/rails. The before mentioned Radio Shack® rectangular magnets would work well on a variety of angular tilt. This tilt ranges from zero degrees to 90 degrees rotational tilt. 23.4° of rotational tilt has been found to work 100% of the time with these rectangular magnets. Some of the same magnets are over nine years old and they still perform at 23.4° of rotational tilt. Shockingly, this same rotational tilt can be found as the tilt of the earth's axis. Why does this 23.4° of rotational tilt on the magnet work? I have no idea. To install this 23.4° of tilt onto or into a rack or rail, the fabrication of a key is highly suggested.

The rotation of the arc-break motion demonstrator's rotor or arm can either be clockwise or counter clockwise. For systems that have the magnet inserted into the rack or rail, the change from clockwise to counter clockwise is easy. For example, flip the rack or rail over and swap the positions of the distributor and controller, if equipped.

The second angle to be discussed is the angle on the moving magnet. The moving magnet is the one on the end of a test arm or rotor. This angle comes into play as a last step before mechanical hook up between the rotor and the distributor. The angle is to set-up for the “rear effect push.” The angle will vary depending on the radius of the test arm or rotor and the degrees of arc with respect to the racks and/or rails.

The potential of the other four angles, though initially avoided, may be mentioned from time to time during this patent application. The design of the test head brings addition angles to life. These angle settings are hard to understand and the slight variations are hard to view on the demonstrators.

Only one angle has an additional purpose other than the original intent. The angle setting for “rear effect push” can be used to show that movement can be achieved even if a rack setting has a zero degree of tilt. This demonstration rapidly changes a person's belief in the widely-known-as-accepted-truth and what can be done.

### Setup

The positions for the non-moving magnets can be found in two places near the border of a circle. The circle can be of any size which, depending on the size of the magnets, can be made to fit. The two positions for placement of the non-moving magnets will be found at the border of a circle. One position, located just outside the circle, is called the “rack” position. The second position, located just inside the circle, is called the “rail” position. Throughout the rest of this application, the units will be either be referred to as a rack demonstrator/engine or a rail demonstrator/engine.

### Racks and Rails

Both racks and rails can be made in such a way that the magnets pivot in their respective mounts for additional timing advantage. These advanced pivoting racks and rails will be extremely difficult to make by hand, limited in rotation due to gap size and/or will require the use of faceted magnets.

### Rack

A rack is a holder of a set of permanent magnets. This holder is located just outside a circle. The number of permanent magnets contained in a rack depends on the gap size between the magnets and the arc length of the rack. The number of rack sets surrounding a circle should be opposite the number of arms of the rotor (rotor and arms of the rotor will be discussed later.) It currently appears that the shorter the arc length of the rack, the more torque can be generated through the rack. Currently, the limit should be no less than three permanent magnets in a rack. If fewer than three permanent magnets are used, directional control becomes a problem. In other words, the rotor arm will bounce backwards. Rack arc lengths of greater than 180° have been demonstrated to work but dead zones developed in the middle of the “fixed angle” rack (“fixed angle” is the placement of each permanent magnet in the rack.) Mobile angle racks in which all the permanent magnets are pivot-able in their respected position and could eliminate the dead zone of the longer rack, but the difficulties have already been discussed.

Fixed angle racks are made by use of a key and made of non-magnetic material. The non-magnetic material can be either wood, aluminum, plastic (etc.) For ease of obtainment and repair, this paper will discuss wood as the non-magnetic material for the racks. The setting of magnets on the rack can either be on top of the board or inserted into the board. The board for setting magnetic on top can be made out of very good grade plywood of about ¾ inch thick. Simple clips for holding magnets in place can be made from the same sheet of plywood. (FIG. 2C). The board for inserting magnetic into can be made out of 2×4's, 2×6's or 2×8's (etc.) Depending on the diameter of the rack engine/demonstrator, the wider the board (example 2×8's) is needed for the smaller diameter rack engine/demonstrator (FIG. 2H). A key (FIG. 2B) cut from a piece of angle iron will made magnet set-up onto the racks extremely easy. Without this “key”, ease of set-up will be lessened. By sliding the key along the inside of the wooden rack arc, placement of magnets will be consistent with respect to one another. See FIG. 2B for details on cutting a 23.4° angle iron key. The key can be used for rack demonstrators or rail demonstrators. Rail keys will require lifts to be used at the outer sliding edges of the key (FIG. 2B.) The word “gap(s)” in this paper will refer to the distance between magnets set onto or into racks. Both rack(s) and rail(s) can use gaps distances slightly greater than the width of the east/west sides of a square or rectangular magnet down to a zero gap between set magnets.

The tab of the key should match the size of the square or rectangular magnet (FIG. 2B) being used. Place the tab on top of the board of choice and mark pattern with a number two pencil or a pen. Then move the key around the arc of board marking the same tab pattern at equal spacing (gaps) for the duration of the arc.

If the magnets are to be mounted on top of the rack, place the magnets in the patterned marked areas and attach magnets with simple clips from FIG. 2C. If magnets are to be inserted into the side of the rack, cut out patterned marked areas and attached the magnet by inserting it into the grooves. If grooves are too loose, drill a hole larger than a plastic wire tie/plastic pull tie, behind the groove. The drilled hole should be as close as possible to the middle of the back of the groove (directly opposite to the opened end of the groove.)

### Arm(s) of Rotor

The arm or arms of the rotor can be made of any non-magnetic material. For the purpose of this paper, wood with brass and stainless steel screws and nuts were used and will described. As stated earlier, the rack and rail demonstrator/engine can be made to any size, depending on the size and strength of the magnets being used, therefore, the arm(s) can be of any length. Weight or mass of each arm is more of a trade-off between lightweight response time and heavyweight rotational inertia.

One magnet will be placed on or near the outside end of each arm. A square magnet can be used at the outside end but a rectangular magnet is definitely superior at this time. The rectangular magnet, by using the long side in the horizontal position (in respect to the rack/rail), catches the magnetic wave (east/west directional wave) better and amplifies any second and third angle adjustment(s) performed on the rotor arms due to the length of the rectangle. The second and/or third angle rotary arm adjustment, to a rectangular magnet, can take the place of a future faceted magnet (a faceted magnet is theoretical and has yet to be made.) Note: the third angle adjustment will create unwanted intermittent perpendicular pressure on each arm. At low speeds, this unwanted pressure is negligible and should not be a concern during early testing and teaching. The third angle adjustment pressure creation can be fixed by very, very fine adjustments to the arms and racks/rails or the creation of faceted magnets.

At one end of each arm, a magnet will be attached. At the opposite end, each arm will be attached to a center mount. This opposite end mount will either slide over a center pin or directly attach to a center axle/shaft. The pin does not rotate and the “axle/shaft” does rotate. Both center pin and center “axle/shaft” arrangements have been tested and both work.

The magnet and mount is made of non-magnetic material and the attaching of the magnet can be performed multiple ways. Suitable magnetic attachment materials will be based on speed and longevity of the demonstrator/engine. Two types of magnetic mounts have been tested and both work. The two types are the straight mount and the drop mount. Straight mounts are superior but cannot be used on a rail demonstrator/engine and with equipment interference's (if these exist) on a rack demonstrator/engine. Drop mounts are mounts that are perpendicular to the arm. A drop mount is used when the arm crosses over the rail or existing equipment interferes on the rack.

Both straight mounts and drop mounts need to be adjustable for testing, teaching and demonstration purposes. At final engine design, neither the straight mount or drop mount should be adjustable. See FIGS. 2G1, 2G2, 2G3 for a simple, adjustable straight mount. See FIG. 2E for a simple adjustable drop mount. FIGS. 2G4, 2G5, 2G6, 2G7 is the test head for attaching to either straight mount or drop mount.

In FIGS. 2G1, 3A, 4A, 4B, 5B, 6A, 6B, 6C, the longer, more slender pieces are 20 to 30 year old shutter louver slats. The older louvers were found to be superior to plywood, of near the same thickness, in the areas of weight, warp resistance, and ease of shaping. The older louvers were solid wood, not laminated and from an unknown tree source. While under a load, the older louvers sagged less and were more twist resistant, than the plywood of near the same thickness. In FIGS. 2G1, 2G4 the louver is shown with an elongated groove or channel cut included. In FIG. 2G2, the cube shape and the L-shaped magnet mount were made from either a yellow or white pine 2×4. The cube shape has a greater than ½-inch hole drilled through the center and two ⅜-inch I.D. Snapper® riding lawn mower plastic bushings (part #13321) installed into both ends of the drilled hold. A ⅜-inch steel rod is then inserted through the plastic bushings. ⅜-inch washers were also installed under the wooden cube to hold the weight vertically. See FIG. 3A for final arrangement on a tabletop demonstrator. Two brass #8×32 each with a matching nut and washer, were screwed into slightly smaller holes in one side of the cube. These screws will be able to adjust the length of the arm via louver arm groove. A finishing nail pointer can be added to an adjacent side of the cube as optional equipment.

The L-shaped magnet mount attaches to the louver arm and a rectangular magnet is attached with masking tape, wire ties or any removable attaching device. The single hole drilled through the magnet face of the L-shaped mount is for attaching (at a later time) the test head in FIG. 2G4. The arm face of the L-shaped mount is attached to the louver arm with a non-magnetic machine screws (#8×32) in such a way as to keep the louver arm cut groove opened and supported. Once built, FIG. 3A is complete and arm distance is adjustable.

FIG. 5C has two new features. One new feature is a clamp type drop mount. The other is a glued instead of screwed arm attachment. The twin wing clamp type drop mount simplifies the design for an adjustable multi-magnet rotor. Gluing instead of screwing also simplifies and reduces the cost of machine type screws/nuts. The twin wing clamp, which is not glued, centers the magnet at the end of the arm by the use of a central mount instead of a side mount, as seen in FIGS. 3A and 4B. The twin wing clamp used the same screw and nut combination as found in FIG. 2F. Tightening the screws will close the clamp on the arm, thus holding the clamp in place. The twin wing clamp mount is cut from a single piece of wood. The gap between the wings is approximately the same measured distance as the thickness of the louver arm.

Gluing instead of screwing also simplifies and reduces the cost of machine type screws and nuts when attaching the arm to the center pin/center shaft mount. Gluing into a center pin/center shaft mount is made easier by use of a small piece(s) of masking tape. This masking tape acts like a spacer to fill a gap prior to gluing the arm to the center rotary mount. Note: always use fresh or new wood glue because once the glue has cured, the glue joint strength is far superior to “old” wood glue.

### Test Head

### FIG. 2G4

The test head is made for testing first, second and possibly third angle adjustments to the rotor arm magnet. See FIGS. 2G4, 2G5, 2G6, 2G7 for details. The entire test head unit is attached with a machine screw and nut to the simple adjustable straight mount, FIG. 2G2. In FIG. 2G2, the near center hole of the L-shaped magnet mount is where the test head is attached. The near center hole on the L-shaped magnet mount is actually centered with the pin drill hole at the other end of the arm.

Simply stated, the test head can rotate a magnet left and right, up and down, clockwise and counterclockwise and have the linear motion of in and out. When used, the test head can find the angle of motion of near any single pole-faced magnet. Each test head will have to be custom made for the magnet to be tested. The magnet is temporarily attached to the test head and tested for the best angle combination for that particular magnet. Note: adding extra wraps of masking tape and tightening down on the machine screws can hold the magnet in place.

### The Demonstrators

There are four demonstrators pertaining to this patent application. All four demonstrators are crudely built using scrap wood if possible. This style of building is done to show that these demonstrators can be built by anyone. Heirloom quality wood working is intimidating as to fit and finished of the wooden pieces. For demonstrators, this intimidation is to be avoided.

The first demonstrator is to show what is currently accepted fact verses what is possible. Current accepted fact is that a magnet cannot jump from one magnet to another; being that these two magnets are of equal strength and are of equal distance from the magnet trying to jump (transition.) This fact is wrong. The second demonstrator shows how magnetic resistance is overcome. The third demonstrator shows how to make a complete revolution with a rotor using an arc-break rack. The fourth demonstrator shows that this rotational energy can then be placed into a flywheel. Once the rotational energy is transferred to a flywheel the game is over. A non-refuel-able motor can be achieved.

### Detailed Descriptions

### All Demonstrators are Set for Counterclockwise Motion

Demonstrator number one is made using a sheet of ¾-inch plywood that is 21¾-inches long and 19 inches wide. Two 2×4 inch boards, cut to 21½ inches long are attached as legs by using nails. A ⅜-inch steel rod as a center pin is installed vertically in one corner of the plywood board and 4⅛-inch distance away from the short side and long side of the plywood board. A single pencil arc line 12½-inches from the center pin was applied to the plywood board. Two seven magnet racks with medium gaps are placed on the outside of the pencil mark. Each rack of approximately 45° or arc has six magnets installed. One rack (2×4 insert style) has its magnets installed at zero degrees of tilt. The other rack (2×4 insert style) has its magnets installed at 23.4° of tilt. A simple arm with a straight mount test head is installed over the center pin using two plastic bushings as bearing. These plastic bushings are Snapper® lawnmower (part number 13321) tie rod bushings. Scrap ¾-inch plywood and steel washers are used as spacers to raise the arm off the surface of the main plywood board. A rope handle is attached for ease of transport through doorways.

Demonstrator number two is made using a sheet of ¾-inch plywood that is 24⅞-inches long and 24⅞-inches wide. Two 2×4-inch boards cut 26⅞-inches long are attached as legs by using nails. Two additional 2×4-inch boards 21¾-inches long are attached as underneath cross braces. A ⅜-inch steel rod as a center pin is installed vertically near one of the short sides of the plywood board. The position of the center pin is 5 1/16′ inches away from one of the short sides of the plywood board. The position of the center pin is 12 5/16-inches away from one of the long sides of the plywood board, and 12 9/16-inches away from the other long side of the plywood board. This time, the center pin is passed through a larger hole in the plywood than ⅜-inch in diameter. An improvement was added to demonstrator number two, as to ensure that the center pin was exactly vertical when installed. On demonstrator number one, the center pin was hammered into a ⅜-inch hole then hammered into the vertical position. On demonstrator number two, a piece of 2×4 board was drilled using a drill press and the ⅜-inch hole. The 2×4 board measured 3½-inches by 3⅜-inches. The 2×4 board with steel rod was then inserted underneath the demonstrator, passing the steel rod up through the hole in the plywood. A top cap board measuring 3½-inches square and ¾-inch thick, with a ⅜-inch hole drilled in its center was pressed down over the steel rod. The top cap board was then attached to the plywood and the underneath 2×4 board using four drywall screws. The same simple arm with test head is installed on the center pin almost exactly like demonstrator number one. The only exception is the additional installation of a hand made protractor. A single pencil arc line 12½-inches from the center pin was applied to the plywood board. One seven magnet rack (with medium gaps and approximately 45° of arc) is placed on the outside of the pencil mark. Two 360° rotating manual magnet holders are installed outside of the pencil mark on either end of the rack. Wooden handles are installed on the rotating magnet holders for the student to control the arc-break magnetic motion. The lead rotating magnet holder is called the controller. The controller draws in the test arm magnet then places it into the magnetic field of the rack. The test arm magnet then leaves the controller and travels into the rack. Once the test arm magnet travels across the face of the rack, it is picked up by the distributor. The distributor is the lag rotating magnet holder. The distributor then discharges the test arm magnet away from the rack. The cycle then repeats itself. A rope handle is also installed.

Demonstrator number three is made using a sheet of ⅝-inch plywood that is cut 43 inches long and 23½-inches wide. Two 2×4-inch boards, 43-inches long are attached as legs by using nails. Two additional 1¾-inches×¾-inch×24⅝-inches boards are attached with drywall screws as underneath cross braces. A ⅜-inch steel rod as a center pin is installed vertically near one of the short sides of the plywood board. The position of the center pin is 13-inches away from one of the short sides of the plywood board. The position of the center pin is 11¾-inches away from both of the long sides of the plywood board. This time, the center pin is very long, approximately 15⅝-inches long. The center pin is passed through a larger hole in the plywood than ⅜-inch in diameter. A piece of 2×4 board was drilled using a drill press and the ⅜-inch rod was placed into the drill pressed ⅜-inch hole. The 2×4 board measured 3½-inches square.

The 2×4 board with steel rod was then inserted underneath the demonstrator, passing the steel rod up through the hole in the plywood. A top cap board measuring (originally) 3⅜-inches square and ⅝-inch thick was used. This time, one corner of the top cap board was cut off forming a 90° arc. The top cap board with a ⅜-inch hole drilled in its center was then pressed down over the steel rod. The top cap board was then attached to the plywood and the underneath 2×4 board using four drywall screws.

The four-arm rotor, with a central hole larger than ½-inch in diameter, is then installed on the center pin and held up with assorted ¼-inch plywood and steel washers. Each arm measures 12⅝-inches long from the center of the center pin to the outside edge of the arm (this measurement includes the 2×4 board mount.) Each arm has a groove cut out of each end approximately 4¼-inches long. The groove width is approximately ¼-inch in width. This groove will allow future 8×32 machine screws to slide back and forth. The rotor is tower shaped with the four rotor arms near the top. The reason for the tower shaped design is to allow for primitive mechanical hook-ups and use of drop mounts. This tower is 6¾-inches high. The tower is made up of one 2×4 boar 3½-inches square, one circular solid wood disc 5½-inches in diameter and 3¾-inches thick, and three 2×4 board rough cut circular to approximately 2⅛-inches in diameter. All five pieces of the tower are held together by two ¼-inch in diameter “all thread” rods. Each “all thread” rod runs parallel to the center pin and approximately 180° apart. ¼-inch nuts and washers compress the tower together when tightened on the ¼-inch “all thread.” The tower rotates around the center pin by using two Snapper® lawnmower (part number 13321) tie rod bushings. One plastic bushing is inserted into the top of the rotor tower and one plastic bushing is inserted into the bottom. The arms of the rotor are installed into the top 2×4 board that has four ¼-inch grooves cut into the middle of each side of the 3½-inch square block. Additional nails, dowels, and wedges were added to each arm connecting point (grooves), due to the fact that I used two year old glue that after the glue cured, it (the glued connection) would not hold up the arm when weighted down. Four twin wing drop mounts were installed each with two Radio Shacks magnets taped to each other. The Radio Shack® magnets are then taped horizontally to the drop mounts and should rest near the middle elevation of the vertically mounted rack magnets. Adjustments to the drop mounts will be required.

Three circular pencil lines are applied to the plywood surrounding the rotor. The first circular pencil line is 12½-inches of the radius from the center point of the center pin. This circular pencil line will not fit entirely on the plywood board, but that is okay. This first semi-circular line is for the placement of the rack. The second circular pencil line is 11 inches of radius from the center point of the center pin. This second circular line if for the alignment of the center seam of the two magnets taped together on each arm of the rotor. The third circular pencil line is 10 inches of radius from the center point of the center pin. This third circular pencil line is the boundary line for the inboard mounted distributor and controller, if the controller is installed.

A single, seven magnet rack with medium gaps and approximately 45° of arc is now installed on the unused portion of the plywood board. Using the fourth magnet in the rack center, the rack equal distance from the two long sides of the plywood. Then place the rack just outside the 12½-inch radius pencil line.

Now for the hard part, the placement of the inboard controller and distributor. These positions work or are at least a starting part for the distributor and controller (if installed) installation. The closest the controller and distributor can currently get is ⅔ the distance from the center seam of the rotor arm magnet to the rack. 1½-inch distance between the center seam of the rotor magnet and rack verses one inch distance between the center seam of the rotor magnet and the controller/distributor.

Look at the middle of the rack. This point would be the middle of the center magnet if an odd number of magnets were installed on/in the rack and the middle of the middle gap if an even number of magnets were installed in or on the rack. Draw a line from the middle of the rack to the center point of the center pin or rotor shaft. This line is called the center line. From the outside part of each end magnet, draw two lines, one line (each magnet) running parallel to the center line and one line (each magnet) to the center point of the center pin or rotor shaft. Note: the outside part of an end magnet is the outside middle of the middle or the point at the outside 25% of the magnet. Now there should be five lines crossing all three circular pencil lines. At the 10-inch radius circular pencil line, trace out the size magnet that will be used as the controller and as the distributor. This position for tracing is between the two outside straight lines (not the center line) and just inside the 10-inch radius circular pencil line. Tracing the magnet(s) directly on top of the parallel lines to the center line is also included in these placement positions. The controller in this position only good at very low speeds to help the student in the classroom maintain rotational momentum. The controller can be removed if a flywheel is attached at low speeds. The controller will have to be moved to the lead magnet on the rack at higher rotational speeds.

The distributor placement can be between the outer parallel line and the line running from the outer magnet to the center pin or shaft. The best positions currently are directly on the outer parallel line. Trace out the magnet to be used just inside the 10-inch radius line and on top of the parallel line. The parallel line should be in the middle of the traced magnet. Mark a center point in the middle of the traced out magnet (this is the point for drilling). This is also the point for a classroom teaching aid's (manual hand crank distributor). Moving away from the 10-inch radius line (go inside away from the rack) trace out three more magnets (back to back) on the parallel line. Again, mark a center point in the middle of the additional traced out magnets (do not drill these points). These additional points are the points for mechanical hook-up of the distributor to the main rotor shaft. The demonstrator, once built, is not designed for increased speeds (lacks shielding, all vibrations removed, wood failure, etc). If you are not aware, one of these magnets broken free, can go through a wall at high speeds, therefore, mechanical hook-up between rotor and distributor is NOT allowed in the classroom. The position(s) for mechanical hook-up are the reference points for a moveable independent distributor mounting base. Going back to the original classroom approved distributor placement, the distributor magnet has to be the same size and strength of the rotor magnets and the rack magnets to achieve the retarded rotational motion required in the classroom. In layman's terms, the student cannot reach high speeds for four reasons: First, the rotor is in the horizontal with all weight pressing down on one point (do not stand this demonstrator up so that the rotor is in the vertical). Secondly, the placement of the distributor exceeds the required ratio for mechanical hook-up. In other words, instead of a 4 to 1 ratio, the student must achieve a 4.28 to 1 ratio (example only) to maintain an accelerating motion. Using your hand is near impossible to control this ratio while system is accelerating. The third reason is “flash-by”. If the student is very quick with his or her hand, for example rotating the distributor at a 6 or 7 to 1 ratio, “flash-by” will occur. “Flash-by” is the one reason most permanent magnet motion machines fail. Magnetic forces, magnetic flux, force of magnetism, or magnetic power does not equal the power required for instantaneous acceleration of a body with mass-nothing does. On-contact-time is required to transfer magnetic force to a mass (even if the mass is another magnet) for acceleration of the mass. It is currently believed that magnetic force (or magnetism) is instantaneous, but the force of acceleration is not. The transfer of magnetic energy to mass acceleration is very, very quick but not instantaneous. To demonstrate “flash-by”, place a magnet on your kitchen table. Reach under your kitchen table with another magnet and slowly pull the tabletop magnet around. Then repeat the process but this time, quickly move the underneath magnet; the tabletop magnet will not move far, if at all. If failure were occurring on previous magnetic motion machines, consider slightly increasing the on-contact-time between the acting magnet and the action magnet. Also consider east/west wave compression (discussed earlier). With just some minor changes, surprises will appear. Once the student with rapid hand movement achieves “flash-by”, the rotor arm magnet slows down then and the rotor stops. The fourth reason why the student operating this demonstrator cannot obtain high rotational speed of the rotor is than an ugly vibration develops slowing down the rotor. This vibration is caused by the flexing of the rotors arms and the length of the drop mounts. Unless an engine is designed to operate via vibration, vibration will slow any motor/engine down. The drop mounts sway back and forth by design. Do not stiffen the arms and/or drop mounts for classroom use.

On the third and fourth demonstrators, the rail system can be placed into operation because of the drop mounts. The rail system can be set to operate either clockwise or counterclockwise, just like the rack system. The rail system is also an arc-break magnetic motion device, just like the rack system. The rail system also uses the 23.4° of non-moving magnet(s) tilt, just like the rack system. The rail system uses the same gap lengths as the rack system. The rail uses inboard and/or outboard controllers and/or distributors same as the rack, except that the words “inboard” and/or “outboard” are referring to opposite positions from the rack. The rail uses the same varying arc lengths and arc radii as the rack. The only difference is that the rail is inside the radius of the rotor. The rail uses the same ratios such as distributors and ⅔ circular pencil placement marks as the rack. The differences are that the rail is on the inside of the rotor, and the magnets of the rail are on the outside of the rail.

Before discussing the fourth demonstrator, the considerations for mechanical hook-up of the distributor to the rotor will be mentioned. Shielding for rotor magnets that have become loose must be thick, complete, and very, very close. Do not have a large gap between the rotor magnets and a shield. Brake system caliper style on the rotor itself should be considered. Do not count on the controller to stop the rotor. Use the moveable mounting bases for the distributor and the controller, to break the distance between the distributor and rack or rail; also to break the distance between the controller and rack or rail.

The timing set mark for the distributor should be for “rear effect push.” “Front effect pull” works but this set up requires more rotation from the distributor and causes an additional magnet mount strain that can be avoided with “rear effect push.” The drop mounts on the counterclockwise rotational rotor experiences the following strains: “left/up/out” and “right/up/out.” These strains are with the rack system, using and inboard distributor, set to the “rear effect push” arrangement. The mounts experience these strains one or more times during each revolution depending on how many racks are around the rotor. An additional strain on the mounts of “left/down/in” is added if the “front effect pull” distributor arrangement is used.

The fourth demonstrator is a vertical version of the third demonstrator. The fourth demonstrator does not have the extended drop mounts and a controller, as the third demonstrator does. The fourth demonstrator has a long 36-inch main shaft with a flywheel attached using friction couplings. The flywheel is actually two weights running perpendicular to the main shaft. The friction couplings slip if the weights come in contact with an object. The same manual hand crank distributor from demonstrator number three is used on demonstrator number four. The main shaft, including the rotor and flywheel, can be removed by removing the rack and unbolting the bearings.

The vertical board is ¾-inch plywood that is cut 32-inches tall and 26-inches wide with two 2×4's added to stiffen the plywood vertically. There is a ¾-inch gap 16½-inches long cut into the plywood for main shaft removal. The same set of three circular pencil marks are made on the vertical board. These are 12½-inch, 11-inch and 10-inch radius circles as found on demonstrator number three. The hand crank distributor mounting hole is in the same location as with demonstrator number three. The rack used is the same style as demonstrator number three—a single seven magnet rack with medium gaps and approximately 45° of arc.

The rotor is different from the rotor on demonstrator number three. The four arm mount for demonstrator number four is 5⅜ inches wide, has 2½-inch notches cut out, and used two drywall screws to attach each arm. This mount is an improvement over the “mess of a mount” on demonstrator number three. Each arm is 13 inches long (including mount) from the main shaft (center shaft) to the outside edge. A ¼-inch groove 4½-inches long is cut into the outer part of the arm to allow movement of the twin wing drop mount. The twin wing drop mounts are shorter (no extension added) so the swaying vibration described in demonstrator number three is reduced. Also, the entire weight is distributed over multiple Snapper® riding lawnmower plastic bushings (part number 13321), not just one as in demonstrator number three. So the only designed speed reduction devices that remain are some rotor arm vibration, distributor still in the retarded motion position, and a very large diameter flywheel.

The flywheel's weights have a greater radius than the distributor placement position. The bottom of each weight has a radius of 10½-inches from the main/center shaft. These distance weights ensure slow rotational speeds. Each weight is made of pine and is 3½-inches in diameter. Each weight is on a threaded ⅜-inch rod, so the weights are adjustable. This adjustment is for balancing the system, but should never go below a 10-inch radius.

The rest of the demonstrator number four is for mounting and adjusting the main shaft. The bottom of the demonstrator is a piece of ¾-inch plywood cut 35⅞-inches long and 17-inches wide. Two 26-inch long 2×4's are placed on top of the plywood base and are used for attachment of three vertical frame mounts. The three vertical frame mounts are approximately 18-inches tall and 12-inches wide. A notch is cut out on all three horizontal pieces of the frame mount for the plastic bushings (main shaft bearings) to be installed. An adjustable rotor shaft thrust stop is installed at the opposite end of the demonstrator number four, to adjust or center the rotor arm magnets with the rack magnets. This thrust stop is a steel flat bar between two ⅜-inch threaded rods. The steel flat bar is moved back and forth along the threaded rods by way of multiple ⅜-inch nuts.

The student operates demonstrator number four by placing himself/herself between the rotor and the flywheel. The student stands behind/besides the vertical plywood board. By using the hand crank manual distributor, the student can achieve ARC-BREAK MAGNETIC MOTION and DRIVE A FLYWHEEL.

### SUPPLEMENTAL

### Due To Unknown Quality Of Built Demonstrators, The Following Guidelines Must Be Adhered To In A Classroom Setting

Mechanical hook-up or connection between the rotor and the distributor is NOT allowed in the classroom. Mechanical connections include use of gears, belt drives, chain drives, cams, pulleys, friction drives and clutches. If another system of mechanical connection exists and is not mentioned above, it (the connection) is also not allowed in the classroom.

Reducing the radius of the flywheel is NOT allowed in the classroom. The flywheel demonstrator is part of this patent and the radius should not be reduced while on school property. Reducing the radius of the flywheel speeds up the rotation of the rotor to the point of mounting failures.

Vibration reduction for the purpose of increasing rotary speed is NOT allowed in the classroom. A vibration occurs at the magnet mount at the end of each arm of the rotor during acceleration of the rotor. This vibration is needed in the classroom because the demonstrator(s) immediately slow down. The vibration is caused by the flexing of the arm(s) of the rotor. The flexing of the arm(s) is caused by the length of the drop mount. Drop mount will be discussed later in the drawing section of this patent application.

Moving the pivot point of the distributor from the “actual motion of influence zone” to the “proposed motion of influence zone” is NOT allowed in the classroom. Depending on the coordination of the individual student, rapid acceleration of the rotor can occur. In keeping the standard magnet on the zone of influence line; the student hand motion must move faster than the ratio or rotation, of the distributor to rotor. In other words, the rotor is being delayed on every hand motion of the student, because at this pivot point, the rotation of the distributor is passed or greater than the required ratio.

“Rear Effect Push” set up on the rotor is not allowed in the classroom. “Rear Effect Push” set up allows an even shorter rotation of the distributor (near ½ of the required ratio.) “Rear Effect Push” set up also has a higher trust generated discharge than the “Front Effect Pull.” “Front Effect Pull” is closer to matching the ratio of rotation of the distributor to rotor.

Non-slip connection for the flywheel to the rotor shaft is NOT allowed in the classroom. The flywheel must slip if the flywheel makes contact with any item, including students. Normally more than one student will end up hanging around the demonstrators. These extra students (the interested ones) will distract each other while standing too close to a demonstrator.

Loose connections, broken connections, and sharp edges are NOT allowed in the classroom. Look for loose connections or broken connections before each class Students can and will break items and not inform the instructor of the demonstrator(s) status. If a demonstrator is found to be damaged, remove it from service until it is repaired.

Rotation greater than 50 RPM is NOT allowed in the classroom. A taped flag marker should be attached to one point/arm of the rotor. The taped mark should make a revolution greater than one second. Stop the student who has achieved a one second or faster rotor revolution.

The above “NOT allowed” list should all be solved with solid metal shielding. A solid metal shielding is the safest way to ensure no damage or injuries will occur during instruction. A solid metal shield will also block all viewing and demonstrating this refer to magnetic motion. Therefore, a solid metal shielded demonstrator is a useless tool in the classroom. Cage type shielding will not prevent shattered magnet fragments from exiting the demonstrator(s). Clear plastic style shielding of the appropriate thickness should work as a final, safe barrier for demonstrators.

Lastly, try all demonstrators before class to acquire experience on the operation of a working demonstrator. This experience is a MUST for showing the students where to stand or sit and proper body position prior to operation a hands-on demonstrator. For most of the demonstrators, the student's hands and arms become contact points. For the flywheel demonstrator, the student's head and back can also become contact points. Therefore, low speed is necessary for all demonstrators

### INVENTOR INTENTIONS

1) Defeat global warming by any means possible. This inventor does believe the scientist's who are warning us about global warming. The two main sources of global warming are coal fire power plants in which Mr. Brady of South Africa's design will work well on replacing (see: www.pureenergysystems.com/news); and vehicle engine exhaust in which this arc-break magnetic motion will hopefully relieve.

2) Teach this motion to whoever is willing to learn. Especially to new inventors.

3) Sell licenses to multiple individuals on the fundamentals. Any improvements to the fundamentals belong to the new inventor while the fundamentals still belong to this inventor and the fundamentals are still protected under one patent. This will prevent lock-down in court for all other inventors who are not contestants in court from proceeding with their improvement(s) and patent arrangements.

4) Financial freedom to retire from my current job to pursue this and other inventions while taking care of my domestic obligations. If this financial freedom is not realized, this inventor will retire at a later date and pursue this and other inventions anyway. It is just a matter of time.

What I claim as my invention is:

1. The arc-break motion(s) with all the variations (except the non-patent-able list).

2. Demonstrators for public education of this arc-break motion (except the non-patent-able list).

3. Any motor developed from this found arc-break motion (except the non-patent-able list).
